(19) United States
(12) Patent Application Publication
(10) Pub. No.: US 2007/0110853 A1
(43) Pub. Date: May 17, 2007

(54) Dimensionally stable sterilizable coextruded film for aseptic packaging

(76) Inventor: Solomon Bekele, Taylors, SC (US)

Correspondence Address: Cryovac, Inc., P.O. Box 464, Duncan, SC, 29334, US

(21) Appl. No.: 11/517,728

(22) Filed: Sep. 8, 2006

Related U.S. Application Data
(63) Continuation-in-part of application No. 11/282,042, filed on Nov. 17, 2005, now abandoned.

(51) Int. Cl. A23B 7/148; B65D 85/00

(52) U.S. Cl. 426/106

(57) ABSTRACT

A coextruded multilayer film includes a core layer including an ethylene vinyl alcohol copolymer; two intermediate layers each including a polyamide; a first outer layer comprising an amorphous cyclic olefin copolymer; a second outer layer comprising an amorphous cyclic olefin copolymer or an olefinic copolymer; and two tie layers each adhering an intermediate layer to a respective outer layer. An aseptic package includes a sterilized food product, and a sterilized pouch in which the sterilized food product is disposed, the sterilized pouch including the coextruded multilayer film of the invention. A method of making an aseptic package is also disclosed.

This application is a continuation-in-part application of U.S. Application Ser. No. 11/282,042 filed Nov. 17, 2005, the contents of which are hereby incorporated by reference.

### FIELD OF THE INVENTION

The invention relates to a coextruded film for aseptic packaging, and to an aseptic package and a method of making an aseptic package.

### BACKGROUND OF THE INVENTION

Aseptic food packaging is a well known method of packaging foods for which sterilization of the food and the packaging material containing the food is required. It is known to produce sterilized packaging in which a sterile food product is placed in a sterilized container such as a pouch. The food product is thus preserved for later storage or use. Various methods of sterilizing the container, and filling the container with a pasteurized product, are known. Hydrogen peroxide is a common medium for sterilization of the packaging material.

In aseptic packaging applications such as vertical form fill seal pouch packaging, where hydrogen peroxide sterilization treatments are used, some films can unduly stretch after being made into a pouch and filled with the sterilized food product at elevated temperatures. These films are thus less desirable or unsuitable for this end use application where dimensional stability of the packaging material is of concern.

One current commercial packaging material for aseptic applications provides such dimensional stability, but in manufacture requires that various components of the material be laminated together. This is a relatively costly means of producing packaging materials. In the commercial laminate, biaxially oriented nylon 6 film is laminated by a conventional lamination adhesive such as polyester to a discrete multilayer substrate film. One commercial film has the construction:

| LDPE | Adh | PA6 | Adh | HDPE | PE | EVOH | LDPE | HDPE |
|---|---|---|---|---|---|---|---|---|
| 2.2 | 0.10 | 0.70 | 0.08 | 0.20 | 0.10 | 0.15 | 0.10 | 0.20 |

Where the values below each resin are the layer gauge in mils, and where:
LDPE = low density polyethylene
Adh = lamination adhesive
PA6 = nylon 6
HDPE = high density polyethylene
PE = polyethylene
EVOH = ethylene/vinyl alcohol copolymer

An important consideration in some aseptic packaging environments is that the packaging material exhibit good dimensional stability under load (e.g. the load of the contained food product when the packaging material is made into a package), and yet remain ductile and abuse resistant under packaging, storage, and transportation conditions. It is desirable that the packaging film possess relatively high storage modulus (E′) (ASTM D5279-01). but also possess relatively high loss modulus (E″) values at temperatures of from −150° C. to 150° C.

Copending patent application U.S. Ser. No. 11/100739, filed 7 Apr. 2005, assigned to a common assignee with the present application, and entitled “Sterilizable Coextruded Film For Aseptic Packaging”, discloses a coextruded multilayer film suitable for packaging products in aseptic conditions. It has been found that when made into pouches, and filled with a food product, where the filled pouch is less than 2 kilograms in weight, the film is dimensionally stable under load in an aseptic environment, i.e. at temperatures of 60° C. However, for heavier filled pouches, the film is less stable dimensionally, and therefore less desirable for aseptic packaging applications.

### SUMMARY OF THE INVENTION

In a first aspect of the present invention, a coextruded multilayer film comprises a core layer comprising ethylene vinyl alcohol copolymer; two intermediate layers each comprising polyamide; a first outer layer comprising amorphous cyclic olefin copolymer; a second outer layer comprising amorphous cyclic olefin copolymer or olefinic copolymer; and two tie layers each adhering an intermediate layer to a respective outer layer.

In a second aspect of the present invention, an aseptic package comprises a sterilized food product, and a sterilized pouch in which the sterilized food product is disposed, the sterilized pouch comprising a coextruded multilayer film comprising a core layer comprising ethylene vinyl alcohol copolymer; two intermediate layers each comprising polyamide; a first outer layer comprising a material selected from the group consisting of amorphous cyclic olefin copolymer, aliphatic homopolyamide, aromatic polyamide, aromatic copolyamide, polycarbonate, polyethylene terephthalate, polyethylene naphthalate, polyethylene terephthalate/naphthalate, and polybutylene naphthalate; a second outer layer comprising a material selected from the group consisting of amorphous cyclic olefin copolymer, aliphatic homopolyamide, aromatic polyamide, aromatic copolyamide, and olefinic copolymer; and two tie layers each adhering an intermediate layer to a respective outer layer.

In a third aspect of the present invention, a method of making an aseptic package comprises sterilizing a food product; sterilizing a coextruded film, the film comprising a core layer comprising an ethylene vinyl alcohol copolymer; two intermediate layers each comprising a polyamide; a first outer layer comprising a material selected from the group consisting of amorphous cyclic olefin copolymer, aliphatic homopolyamide, aromatic polyamide, aromatic copolyamide, polycarbonate, polyethylene terephthalate, polyethylene naphthalate, polyethylene terephthalate/naphthalate, and polybutylene naphthalate; a second outer layer comprising a material selected from the group consisting of amorphous cyclic olefin copolymer, aliphatic homopolyamide, aromatic polyamide, aromatic copolyamide, and olefinic copolymer; and two tie layers each adhering an intermediate layer to a respective outer layer;.wherein the film exhibits an elongation at yield (ASTM D 882) of less than 15% in each of the longitudinal and transverse directions, and a free shrink (ASTM D 2732) at 200° F. of less than 8% in each of the longitudinal and transverse directions; forming the sterilized film into a pouch; filling the pouch with the sterilized food product; and sealing the pouch.

In at least some embodiments of the invention, the film is characterized by an elongation at yield (ASTM D 882) of less than 15% in each of the longitudinal and transverse directions, and/or a free shrink (ASTM D 2732) at 200° F. of less than 8% in each of the longitudinal and transverse directions.

Definitions

“Aseptic” herein refers to a process wherein a sterilized container or packaging material, e.g. a pre-made pouch or a pouch constructed in a vertical form/fill/seal process, is filled with a sterilized food product, in a hygienic environment. The food product is thus rendered shelf stable in normal nonrefrigerated conditions. “Aseptic” is also used herein to refer to the resulting filled and closed package. The package or packaging material, and the food product, are typically separately sterilized before filling.

“High density polyethylene” is an ethylene homopolymer or copolymer with a density of 0.940 g/cc or higher.

“Polypropylene” is a propylene homopolymer or copolymer having greater than 50 mole percent propylene prepared by conventional heterogeneous Ziegler-Natta type initiators or by single site catalysis. Propylene copolymers are typically prepared with ethylene or butene comonomers.

“Ethylene/alpha-olefin copolymer” (EAO) herein refers to copolymers of ethylene with one or more comonomers selected from C₃ to C₁₀ alpha-olefins such as propene, butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ and ATTANE™ resins supplied by Dow, and ESCORENE™ resins supplied by Exxon; as well as linear homogeneous ethylene/alpha olefin copolymers (HEAO) such as TAFMER™ resins supplied by Mitsui Petrochemical Corporation, EXACT™ and EXCEED™ resins supplied by Exxon, long chain branched (HEAO) AFFINITY™ resins and ELITE™ resins supplied by the Dow Chemical Company, ENGAGE™ resins supplied by DuPont Dow Elastomers, and SURPASS™ resins supplied by Nova Chemicals.

“Ethylene homopolymer or copolymer” herein refers to ethylene homopolymer such as low density polyethylene; ethylene/alpha olefin copolymer such as those defined herein; ethylene/vinyl acetate copolymer; ethylene/alkyl acrylate copolymer; ethylene/(meth)acrylic acid copolymer; or ionomer resin.

“Multicomponent ethylene/alpha-olefin interpenetrating network resin” or “IPN resin” herein refers to multicomponent molecular mixtures of polymer chains. Because of molecular mixing, IPN resins cannot be separated without breaking chemical bonds. Polymer chains combined as IPN resins are interlaced at a molecular level and are thus considered true solid state solutions. Interpenetrating networks, unlike blends, become new compositions exhibiting properties distinct from parent constituents. Interpenetrating networks provide phase co-continuity leading to surprising enhancement of physical properties. Due to the mixture of at least two molecular types, these compositions may exhibit bimodal or multimodal curves when analyzed using TREF or CRYSTAF. Interpenetrating networks as herein used includes semi-interpenetrating networks and therefore describes crosslinked and uncrosslinked multicomponent molecular mixtures having a low density fraction and a high density fraction.

“Olefinic” and the like herein refers to a polymer or copolymer derived at least in part from an olefinic monomer.

“Polyamide” herein refers to polymers having amide linkages along the molecular chain, and preferably to synthetic polyamides such as nylons.

“Cyclic olefin” herein means a compound containing a polymerizable carbon-carbon double bond that is either contained within an alicyclic ring, e.g., as in norbornene, or linked to an alicyclic ring, e.g., as in vinyl cyclohexane. Polymerization of the cyclic olefin provides a polymer comprising an alicyclic ring as part of or pendant to the polymer backbone.

“Cyclic olefin copolymer” and the like herein (e.g. “cycloolefin copolymer”) means a copolymer formed by polymerization of a cyclic olefin with a comonomer. An example of a cyclic olefin copolymer is ethylene/norbornene copolymer, such as that supplied by Ticona under the trademark TOPAS™, by Zeon under the trademark ZEONOR™ and by Mitsui under the trademark APEL™.

“Polymer” and the like herein means a homopolymer, but also copolymers thereof, including bispolymers, terpolymers, etc.

All compositional percentages used herein are presented on a “by weight” basis, unless designated otherwise.

### DETAILED DESCRIPTION OF THE INVENTION

The Aseptic Process

Aseptic packaging typically involves the sterilization of liquid foods and beverages outside the package, and separate sterilization of the packaging material, to produce a shelf stable package. Ultra high temperature is used to rapidly heat the food product, followed by cooling of the product, before the product is put into the pouch or other container formed from the packaging material. Processing times for the product are generally 3 to 15 seconds; temperatures range from about 195° F. to 285° F.

Film Sterilization

An example of a commercially available aseptic form/fill/seal equipment system is the ONPACK™ KAF 2000 system having a film sterilization section including a tank for hydrogen peroxide, a drying chamber, a form/fill/seal section, and a unit which supplies and circulates hydrogen peroxide and controls temperature, air pressure etc. Film is continuously sterilized by hydrogen peroxide set at a temperature of between 60° C. and 80° C. in a chemical tank. After film leaves this tank, hot air at a temperature of between 60° C. and 80° C. is used to dry out the film to remove hydrogen peroxide from the film. Temperature and flow level for the hydrogen peroxide is controlled by steam to raise temperature, and water is supplied for cooling. Piping between the food sterilizer and the packaging unit can be initially sterilized using steam heat or hot water. After film exits the peroxide tank, the film is scraped by plates and by an air knife to make it easy to dry.

### Film Embodiments of the Invention

A representative film structure of some embodiments of the invention is as follows:

| Material | | | | | | |
|---|---|---|---|---|---|---|
| of layer G, | | | | | | |
| or | | | | | | Amorphous |
| polyolefin | Tie | nylon | EVOH | Nylon | Tie | material |
| A | B | C | D | E | F | G |

Core layer D of the above film structure can comprise any suitable EVOH material, and can be blended in any proportion with other polymeric materials or organic or inorganic additives as desired.

Intermediate layers C and E each comprise a polyamide, such as a semicrystalline polyamide such as nylon 6. The composition of layers C and E can differ, e.g. can comprise different polyamides; or can be the same. In one embodiment, layers C and E can each comprise a blend of an amorphous polyamide and a semicrystalline polyamide. In such an embodiment, the amorphous polyamide can comprise any suitable percent of the overall polyamide blend, and can comprise e.g. less than 50 wt. %, such as less than 40 wt. %, and less than 30 wt. % of the polyamide blend of layers C and E. The amorphous polyamide can comprise from 5 to 45 wt. %, such as from 20 to 40 wt. %, such as from 25 to 35 wt. % of the polyamide blend of layers C and E. The blend ratios of layers C and E can be the same, or can differ.

Useful commercially available amorphous polyamides include FE4494™ and FE4495™. These are PA61/66/69 polyamides available from EMS. Also useful is FE7103™, a PA61/MXDI polyamide available from EMS.

Other amorphous polyamides that can be used are PA66/6T; PA66/6I; PA661/66T; PA6/6T; and PA6/6I. Also useful is PA6/3/T available from Degussa as TROGAMID™, and PA61/6T available from DuPont as SELAR™ PA 3426.

The amorphous polyamide has in one embodiment a glass transition temperature of at least 80° C.

The semicrystalline polyamide can be any suitable polyamide, including nylon 6.

The semicrystalline polyamide can comprise any suitable percent of the overall polyamide blend, and can comprise e.g. more than 50 wt. %, such as more than 60 wt.%, and more than 70 wt. % of the polyamide blend of layers C and E. The semicrystalline polyamide can comprise from 55 to 95 wt. %, such as from 60 to 80 wt. %, such as from 65 to 75 wt. % of the polyamide blend of layers C and E.

The semicrystalline polyamide in one embodiment has a glass transition temperature of at least 55° C.

Tie layers B and F can comprise any suitable polymeric adhesive that functions to bond two layers together. Materials that can be used in embodiments of the present invention include e.g. ethylene/vinyl acetate copolymer; anhydride grafted ethylene/vinyl acetate copolymer; anhydride grafted ethylene/alpha olefin copolymer; anhydride grafted polypropylene; anhydride grafted low density polyethylene; ethylene/methyl acrylate copolymer; anhydride grafted high density polyethylene, ionomer resin, ethylene/acrylic acid copolymer; ethylene/methacrylic acid copolymer; and anhydride grafted ethylene/methyl acrylate copolymer. A suitable anhydride can be maleic anhydride. Tie layers B and F can be the same, or can differ. The choice of tie layers depends at least in part on the choice of polymer for the outer layers A and G respectively.

Layer A will typically function as a sealant layer of the film. This layer can comprise one or more semicrystalline olefinic polymers. Polymers that may be used for the layer A include ethylene polymer or copolymer, ethylene/alpha olefin copolymer, ethylene/vinyl acetate copolymer, ionomer resin, ethylene/acrylic or methacrylic acid copolymer, ethylene/acrylate or methacrylate copolymer, low density polyethylene, high density polyethylene, propylene homopolymer, propylene/ethylene copolymer, or blends of any of these materials.

Alternatively, layer A can comprise a material as defined herein for layer G.

Layer G comprises an amorphous polymer with a relatively high glass transition temperature (Tg).

Layer G comprises in one embodiment amorphous cyclic olefin copolymer. In another embodiment, layer G comprises a blend of a) amorphous cyclic olefin copolymer, aliphatic polyamide, aromatic polyamide, and/or aromatic copolyamide, and (b) semicrystalline olefinic polymer.

The amorphous polymer of layer G is characterized by a glass transition temperature (Tg) of greater than about 30° C., such as between 60° C. and 160° C., between 65° C. and 140° C., and between 70° C. and 120° C. Examples of such materials include ethylene/norbornene copolymer (ENB), recently available from Ticona under the trademark TOPAS™. Various grades are available, including (with glass transition temperature indicated in parenthesis) TKX-0001™ (136° C.), 5010L™ (110° C.), 5013S™ (136° C.), 6013F™ (140° C.), 6015S™ (160° C.), 6017S™ (180° C.), 9506X1™ (68° C. reported/33° C. measured), and 8007 F-04™ (80° C.).

Other cyclic olefin copolymers are available from Mitsui under the trademark APEL™. Various grades are available, including (with glass transition temperature indicated in parenthesis) 8008T™ (70° C.), 6509T™ (80° C.), 6011T™ (115° C.), 6013T™ (135° C.), 6015T™ (155° C.), and 6014D™ (147° C.).

Examples of polymers or copolymers having a glass transition temperature (Tg) of greater than about 60° C. are aliphatic homopolyamide such as nylon 6, aromatic polyamide or copolyamide, polycarbonate (Tg=147° C. to 150° C.), polyethylene terephthalate (Tg=80° C.), polyethylene naphthalate (Tg=125° C.), polyethylene terephthalate/naphthalate (Tg=80° C. to 120° C.), and polybutylene naphthalate (Tg=82° C.).

In one embodiment, layer G can comprise one outermost layer of the film such that when formed into a pouch, layer G comprises the layer furthest from the packaged product; and an olefinic polymer or copolymer such as ethylene/alpha olefin copolymer (EAO) can comprise the inner layer A of the film, such that when formed into a pouch, the EAO comprises the layer closest to the packaged product. In this embodiment, the film can be lap sealed, for example a longitudinal lap seal running the length of the pouch, such that layer G is sealed to the EAO inner layer A. This embodiment provides a longitudinally lap sealed pouch.

Pouches made from the film of the present invention can be fin sealed or lap sealed (typically referring to the longitudinal seal running the length of the pouch) depending on the desired configuration of the finished pouch, the equipment used, and the composition of the two outer layers. In the case of fin seals, where the same layer A is sealed to itself at the longitudinal edges of the material web, in one embodiment the outer layer that will come together to form the fin seal comprises a material with a melting point of at least 125° C., e.g. high density polyethylene or propylene homopolymer.

Alternatively, both layers A and G can comprise the blend of amorphous and semicrystalline materials described above for layer G. In this embodiment, the film can be either lap sealed or fin sealed to form a pouch.

Additional materials that can be incorporated into one or both of the outer layers of the film, and in other layers of the film as appropriate, include antiblock agents, slip agents, antifog agents, etc.

Other additives can also be included in the composition to impart properties desired for the particular article being manufactured. Such additives include, but are not necessarily limited to, fillers, pigments, dyestuffs, antioxidants, stabilizers, processing aids, plasticizers, fire retardants, UV absorbers, etc.

Additional materials, including polymeric materials or other organic or inorganic additives, can be added to any or all of the layers of the above structures as needed, and additional film layers can be included either within the film structure, or adhered to an outer layer thereof.

In general, the film can have any total thickness desired, and each layer can have any thickness desired, so long as the film provides the desired properties for the particular packaging operation in which the film is used. Typical total thicknesses are from 0.5 mils to 15 mils, such as 1 mil to 12 mils, such as 2 mils to 10 mils, 3 mils to 8 mils, and 4 mils to 6 mils.

### EXAMPLES

Several film structures in accordance with the invention, and comparatives, are identified below. Materials used were as follows.

TABLE 1
Resin Identification

| Material | Tradename Or | |
|---|---|---|
| Code | Designation | Source(s) |
| AB1 | 10853 | Ampacet |
| AB2 | LP-142698/502815 ™ | Ampacet |
| AB3 | 502835 ™ | Ampacet |
| PE1 | DOW ™ 609A | Dow |
| PE2 | ELITE ™ 5400 G | Dow |
| PE3 | PE 12450 N ™ | Dow |
| PE4 | DOW ™ 2045.04 | Dow |
| PE5 | 662I ™ | Dow |
| PE6 | T50-200 ™ | Innovene |
| AD1 | PX3236 ™ | Equistar |
| AD2 | ADMER ™ QB 510A | Mitsui |
| AD3 | PX3410 ™ | Equistar |
| AD4 | PLEXAR ™ PX2246 | Equistar |
| AD5 | PLEXAR ™ 2220 ™ | Equistar |
| AD6 | PLEXAR ™ 2612X01 | Equistar |
| AD7 | ADMER ™ AT1053A | Mitsui |
| PA1 | ULTRAMID ™ B40 01 | BASF |
| PA2 | GRIVORY ™ G21 | EMS |
| PA3 | ULTRAMID ™ B40LN01 | BASF |
| OB1 | EVAL ™ L171B | Evalca |
| PP1 | EOD00-07 ™ | Total Petrochemicals |
| PP2 | EOD01-30 ™ | Total Petrochemicals |
| PP3 | FINACENE ™ EOD01-04 ™ | Total Petrochemicals |
| PP4 | ESCORENE PP-9302 E1 ™ | ExxonMobil |
| EN1 | TOPAS 9506X1 ™ | Ticona |
| EN2 | TOPAS 8007 F-04 ™ | Ticona |
| EA1 | NUCREL ™ 31001 | DuPont |
| EA2 | PRIMACOR ™ 1410 | Dow |
| IO1 | SURLYN ™ 1650 | DuPont |
| IO2 | SURLYN ™ 1857 | DuPont |

AB1 is a masterbatch having about 80%, by weight of the masterbatch, of linear low density polyethylene, and about 20%, by weight of the masterbatch, of an antiblocking agent (diatomaceous earth).

AB2 is a masterbatch having about 89.5%, by weight of the masterbatch, of FORTIFLEX™ T60-500-119, a high density polyethylene with a density of 0.961 grams/cc; about 8%, by weight of the masterbatch, of SILTON JC30A™, a sodium calcium aluminum silicate, NaCaAl(Si₂O₇); about 2 w %, by weight of the masterbatch, of CLEAR Block8O™ talc, an antiblocking agent; and about 0.5%, by weight of the masterbatch, of erucamide, a slip agent.

AB3 is a masterbatch having about 80%, by weight of the masterbatch, of FORTIFLEX™ T60-500-119, a high density polyethylene with a density of 0.961 grams/cc; about 16%, by weight of the masterbatch, of SILTON JC30A™, a sodium calcium aluminum silicate, NaCaAl(Si₂O₇); and about 4 w %, by weight of the masterbatch, of CLEAR Block80™ talc, an antiblocking agent.

PE1 is a low density polyethylene resin.

PE2 is an IPN resin with a density of 0.917 grams/cc, and a melt flow index of 1.0.

PE3 is an ethylene/1-octene copolymer with a density of 0.950 grams/cc.

PE4 is an ethylene/octene-1 copolymer with a 6.5 weight % octene content, and a density of 0.920 grams/cc.

PE5 is a low density polyethylene resin.

PE6 is an ethylene/i -butene copolymer resin with a density of 0.952 grams/cc.

AD1 is a maleic anhydride-modified linear low density polyethylene with a density of 0.921 grams/cc.

AD2 is a maleic anhydride-modified polypropylene.

AD3 is a maleic anhydride-modified linear low density polyethylene.

AD4 is a maleic anhydride-modified high density polyethylene with a melt flow rate of 0.60 g/10 min per ASTM D1238, a density of 0.95g/cc per ASTM D1505 and a Vicat softening point of 124 degrees Celsius per ASTM 1525.

AD5 is a maleic anhydride-modified high density polyethylene with a melt flow rate of 5.5 g/10 min per ASTM D1238, a density of 0.943 g/cc per ASTM 1505 and a Vicat softening point of 112 degrees Celsius per ASTM 1525.

AD6 is a maleic anhydride-modified high density polyethylene with a melt flow rate of 2.5 g/10 min per ASTM D1238, a density of 0.95g/cc per ASTM D1505 and a Vicat softening point of 124 degrees Celsius per ASTM 1525.

AD7 is a maleic anhydride-modified linear low density polyethylene.

PA1 is a nylon 6 (poly(caprolactam)).

PA2 is an amorphous nylon, i.e. a poly(hexamethylene diamine/isophthalic acid/terephthalic acid).

PA3 is a nylon 6 (poly(caprolactam)).

OB1 is an ethylene/vinyl alcohol copolymer with less than 30 mole % ethylene.

PP1 is a single site catalyzed isotactic propylene homopolymer with a melt flow rate of 8 grams/10 minutes, ASTM D-1238 condition L, and a density 0.90 g/cc per ASTM D-1505.

PP2 is a single site catalyzed isotactic propylene homopolymer with a melt flow rate of 4 grams/10 minutes, ASTM D-1238 condition L, and a density 0.90g/cc per ASTM D-1505.

PP3 is a single site catalyzed isotactic propylene/ethylene copolymer with a melt flow rate of 8 grams/10 minutes, ASTM D-1238 condition L, and a density 0.90 g/cc per ASTM D-1505.

PP4 is a Ziegler/Natta catalyzed isotactic propylene/ethylene copolymer with a melt flow rate of 8 grams/10 minutes, ASTM D-1238 condition L, and a density 0.90 g/cc per ASTM D-1505.

EN1 is an ethylene/norbornene copolymer with a norbornene content of 25 mole % of the copolymer and a reported Tg of 68° C., and a measured Tg of 33° C.

EN2 is an ethylene/norbornene copolymer with a norbornene content of 36 mole % of the copolymer and a Tg of 80° C.

EA1 is an ethylene/acrylic acid copolymer with an acrylic acid content of 9.2% by weight of the copolymer.

EA2 is an ethylene/acrylic acid copolymer with an acrylic acid comonomer content, by weight of the copolymer, of less than 10%.

IO1 is a zinc neutralized ethylene methacrylic acid copolymer.

IO2 is a zinc neutralized ethylene/methacrylic acid/isobutyl acrylate terpolymer.

All compositional percentages given herein are by weight, unless indicated otherwise.

The following films were made by otherwise conventional coextrusion techniques.

TABLE 2
Film structures

| | Layers | | | | | | |
|---|---|---|---|---|---|---|---|
| Example | A | B | C | D | E | F | G |
| Comp. 1 | 7% AB1 + 23% | AD1 | 70% PA1 + 30% | OB1 | 70% PA1 + 30% | AD1 | 5% AB1 + 95% |
| | PE1 + 70% | | PA2 | | PA2 | | PP1 |
| | PE2 | | | | | | |
| Mils | 1.80 | 0.25 | 0.65 | 0.50 | 0.65 | 0.25 | 0.90 |
| Vol % | 36.0 | 5.0 | 13.0 | 10.0 | 13.0 | 5.0 | 18.0 |
| Ex. 1 | 7% AB1 + 23% | AD1 | 70% PA1 + 30% | OB1 | 70% PA1 + 30% | AD1 | 80% EN1 + 16% |
| | PE1 + 70% | | PA2 | | PA2 | | PE3 + 4% |
| | PE2 | | | | | | AB1 |
| Mils | 1.80 | 0.25 | 0.65 | 0.65 | 0.50 | 0.25 | 0.90 |
| Vol % | 36.0 | 5.0 | 13.0 | 13.0 | 10.0 | 5.0 | 18.0 |
| Ex. 2 | 7% AB1 + 23% | AD1 | 70% PA1 + 30% | OB1 | 70% PA1 + 30% | AD1 | 80% EN1 + 16% |
| | PE1 + 70% | | PA2 | | PA2 | | PE1 + 4% |
| | PE2 | | | | | | AB1 |
| Mils | 1.80 | 0.25 | 0.65 | 0.50 | 0.65 | 0.25 | 0.90 |
| Vol % | 36.0 | 5.0 | 13.0 | 10.0 | 13.0 | 5.0 | 18.0 |
| Ex. 3 | 7% AB1 + 23% | AD1 | 70% PA1 + 30% | OB1 | 70% PA1 + 30% | AD1 | 80% EN1 + 16% |
| | PE1 + 70% | | PA2 | | PA2 | | PP1 + 4% |
| | PE2 | | | | | | AB1 |
| Mils | 1.80 | 0.25 | 0.65 | 0.50 | 0.65 | 0.25 | 0.90 |
| Vol % | 36.0 | 5.0 | 13.0 | 10.0 | 13.0 | 5.0 | 18.0 |
| Ex. 4 | 7% AB1 + 23% | AD1 | 70% PA1 + 30% | OB1 | 70% PA1 + 30% | AD1 | 80% EN1 + 16% |
| | PE1 + 70% | | PA2 | | PA2 | | PP2 + 4% |
| | PE2 | | | | | | AB1 |
| Mils | 1.80 | 0.25 | 0.65 | 0.50 | 0.65 | 0.25 | 0.90 |
| Vol % | 36.0 | 5.0 | 13.0 | 10.0 | 13.0 | 5.0 | 18.0 |
| Ex. 5 | 7% AB1 + 23% | AD1 | 70% PA1 + 30% | OB1 | 70% PA1 + 30% | AD1 | 80% EN2 + 16% |
| | PE1 + 70% | | PA2 | | PA2 | | PE1 + 4% |
| | PE2 | | | | | | AB1 |
| Mils | 1.80 | 0.25 | 0.65 | 0.50 | 0.65 | 0.25 | 0.90 |
| Vol % | 36.0 | 5.0 | 13.0 | 10.0 | 13.0 | 5.0 | 18.0 |
| Ex. 6 | 7% AB1 + 23% | AD1 | 70% PA1 + 30% | OB1 | 70% PA1 + 30% | AD1 | 80% EN2 + 16% |
| | PE1 + 70% | | PA2 | | PA2 | | PE3 + 4% |
| | PE2 | | | | | | AB1 |
| Mils | 1.80 | 0.25 | 0.65 | 0.50 | 0.65 | 0.25 | 0.90 |
| Vol % | 36.0 | 5.0 | 13.0 | 10.0 | 13.0 | 5.0 | 18.0 |
| Comp. 2 | 7% AB1 + 23% | AD2 | 70% PA1 + 30% | OB1 | 70% PA1 + 30% | AD2 | 96% PP1 + 4% |
| | PE1 + 70% | | PA2 | | PA2 | | AB1 |
| | PE2 | | | | | | |
| Mils | 1.80 | 0.25 | 0.65 | 0.50 | 0.65 | 0.25 | 0.90 |
| Vol % | 36.0 | 5.0 | 13.0 | 10.0 | 13.0 | 5.0 | 18.0 |
| Comp. 3 | 7% AB1 + 23% | AD2 | 70% PA1 + 30% | OB1 | 70% PA1 + 30% | AD2 | 96% PP2 + 4% |
| | PE1 + 70% | | PA2 | | PA2 | | AB1 |
| | PE2 | | | | | | |
| Mils | 1.80 | 0.25 | 0.65 | 0.50 | 0.65 | 0.25 | 0.90 |
| Vol % | 36.0 | 5.0 | 13.0 | 10.0 | 13.0 | 5.0 | 18.0 |

TABLE 3
Film structures

| | Layers | | | | | | |
|---|---|---|---|---|---|---|---|
| Example | A | B | C | D | E | F | G |
| Ex. 7 | 7% AB1 + 23% | AD1 | 70% PA1 + 30% | OB1 | 70% PA1 + 30% | AD1 | 80% EN1 + 15% |
| | PE1 + 70% | | PA2 | | PA2 | | PP1 + 5% |
| | PE4 | | | | | | AB1 |
| A[127μ] | | | | | | | |
| Mils | 2.00 | 0.20 | 0.53 | 0.55 | 0.52 | 0.20 | 1.00 |
| Vol % | 40.0 | 4.0 | 10.6 | 11.0 | 10.4 | 4.0 | 20.0 |
| B[152μ] | | | | | | | |
| Mils | 2.40 | 0.30 | 0.60 | 0.60 | 0.60 | 0.30 | 1.20 |
| Vol % | 40.0 | 5.0 | 10.0 | 10.0 | 10.0 | 5.0 | 20.0 |
| Ex. 8 | 7% AB1 + 23% | AD1 | 70% PA1 + 30% | OB1 | 70% PA1 + 30% | AD1 | 80% EN2 + 15% |
| | PE1 + 70% | | PA2 | | PA2 | | PP1 + 5% |
| | PE4 | | | | | | AB1 |
| A[127μ] | | | | | | | |
| Mils | 2.00 | 0.20 | 0.53 | 0.55 | 0.52 | 0.20 | 1.00 |
| Vol % | 40.0 | 4.0 | 10.6 | 11.0 | 10.4 | 4.0 | 20.0 |
| B[152μ] | | | | | | | |
| Mils | 2.40 | 0.30 | 0.60 | 0.60 | 0.60 | 0.30 | 1.20 |
| Vol % | 40.0 | 5.0 | 10.0 | 10.0 | 10.0 | 5.0 | 20.0 |
| Ex. 9 | 7% AB1 + 23% | AD1 | 70% PA1 + 30% | OB1 | 70% PA1 + 30% | AD1 | 80% EN2 + 15% |
| | PE1 + 70% | | PA2 | | PA2 | | PE1 + 5% |
| | PE4 | | | | | | AB1 |
| A[127μ] | | | | | | | |
| Mils | 2.00 | 0.20 | 0.53 | 0.55 | 0.52 | 0.20 | 1.00 |
| Vol % | 40.0 | 4.0 | 10.6 | 11.0 | 10.4 | 4.0 | 20.0 |
| B[152μ] | | | | | | | |
| Mils | 2.40 | 0.30 | 0.60 | 0.60 | 0.60 | 0.30 | 1.20 |
| Vol % | 40.0 | 5.0 | 10.0 | 10.0 | 10.0 | 5.0 | 20.0 |
| C[107μ] | | | | | | | |
| Mils | 1.64 | 0.16 | 0.43 | 0.55 | 0.42 | 0.16 | 0.84 |
| Vol % | 40.0 | 4.0 | 10.4 | 13.1 | 10.3 | 4.0 | 20.0 |
| Ex. 10 | 7% AB1 + 23% | AD1 | 70% PA1 + 30% | OB1 | 70% PA1 + 30% | AD1 | 80% EN2 + 15% |
| | PE1 + 70% | | PA2 | | PA2 | | PE3 + 5% |
| | PE4 | | | | | | AB1 |
| A[127μ] | | | | | | | |
| Mils | 2.00 | 0.20 | 0.53 | 0.55 | 0.52 | 0.20 | 1.00 |
| Vol % | 40.0 | 4.0 | 10.6 | 11.0 | 10.4 | 4.0 | 20.0 |
| B[152μ] | | | | | | | |
| Mils | 2.40 | 0.30 | 0.60 | 0.60 | 0.60 | 0.30 | 1.20 |
| Vol % | 40.0 | 5.0 | 10.0 | 10.0 | 10.0 | 5.0 | 20.0 |

TABLE 4
Film structures

| | Layers | | | | | | |
|---|---|---|---|---|---|---|---|
| Example | A | B | C | D | E | F | G |
| Ex. 11 | 8% AB1 + 22% | AD1 | 70% PA1 + 30% | OB1 | 70% PA1 + 30% | AD1 | 60% EN2 + 15% |
| | PE5 + 70% | | PA2 | | PA2 | | PE5 + 20% |
| | PE4 | | | | | | PE2 + 5% |
| | | | | | | | AB1 |
| A[107μ] | | | | | | | |
| Mils | 1.26 | 0.16 | 0.42 | 0.50 | 0.42 | 0.16 | 1.26 |
| Vol % | 30.0 | 4.0 | 10.0 | 12.0 | 10.0 | 4.0 | 30.0 |
| B[127μ] | | | | | | | |
| Mils | 2.00 | 0.20 | 0.53 | 0.55 | 0.52 | 0.20 | 1.00 |
| Vol % | 40.0 | 4.0 | 10.6 | 11.0 | 10.4 | 4.0 | 20.0 |
| C[152μ] | | | | | | | |
| Mils | 1.80 | 0.30 | 0.60 | 0.60 | 0.60 | 0.30 | 1.80 |
| Vol % | 30.0 | 5.0 | 10.0 | 10.0 | 10.0 | 5.0 | 30.0 |
| D[127μ] | | | | | | | |
| Mils | 1.5 | 0.20 | 0.53 | 0.55 | 0.52 | 0.20 | 1.5 |
| Vol % | 30.0 | 4.0 | 10.6 | 11.0 | 10.4 | 4.0 | 30.0 |
| Ex. 12 | 6% AB2 + 24% | AD1 | 70% PA1 + 30% | OB1 | 70% PA1 + 30% | AD1 | 53% EN2 + 19% |
| | PE1 + 70% | | PA2 | | PA2 | | PE1 + 24% |
| | PE4 | | | | | | PE2 + 4% |
| | | | | | | | AB2 |
| A[107μ] | | | | | | | |
| Mils | 1.26 | 0.16 | 0.42 | 0.50 | 0.42 | 0.16 | 1.26 |
| Vol % | 30.0 | 4.0 | 10.0 | 12.0 | 10.0 | 4.0 | 30.0 |
| B[127μ] | | | | | | | |
| Mils | 1.50 | 0.20 | 0.53 | 0.55 | 0.52 | 0.20 | 1.50 |
| Vol % | 30.0 | 4.0 | 10.6 | 11.0 | 10.4 | 4.0 | 30.0 |
| C[152μ] | | | | | | | |
| Mils | 1.80 | 0.30 | 0.60 | 0.60 | 0.60 | 0.30 | 1.80 |
| Vol % | 30.0 | 5.0 | 10.0 | 10.0 | 10.0 | 5.0 | 30.0 |
| Ex. 13 | 7% AB1 + 23% | AD1 | 70% PA1 + 30% | OB1 | 70% PA1 + 30% | AD1 | 53% EN2 + 24% |
| | PE1 + 70% | | PA2 | | PA2 | | PE2 + 19% |
| | PE4 | | | | | | PE3 + 4% |
| | | | | | | | AB2 |
| A[107μ] | | | | | | | |
| Mils | 1.26 | 0.16 | 0.42 | 0.50 | 0.42 | 0.16 | 1.26 |
| Vol % | 30.0 | 4.0 | 10.0 | 12.0 | 10.0 | 4.0 | 30.0 |
| B[127μ] | | | | | | | |
| Mils | 1.50 | 0.20 | 0.53 | 0.55 | 0.52 | 0.20 | 1.50 |
| Vol % | 40.0 | 4.0 | 10.6 | 11.0 | 10.4 | 4.0 | 30.0 |
| C[152μ] | | | | | | | |
| Mils | 1.80 | 0.30 | 0.60 | 0.60 | 0.60 | 0.30 | 1.80 |
| Vol % | 30.0 | 5.0 | 10.0 | 10.0 | 10.0 | 5.0 | 30.0 |
| Ex. 14 | 7% AB1 + 23% | AD1 | 70% PA1 + 30% | OB1 | 70% PA1 + 30% | AD1 | 53% EN2 + 24% |
| | PE1 + 70% | | PA2 | | PA2 | | PE2 + 19% |
| | PE4 | | | | | | PP3 + 4% |
| | | | | | | | AB2 |
| A[107μ] | | | | | | | |
| Mils | 1.26 | 0.16 | 0.42 | 0.50 | 0.42 | 0.16 | 1.26 |
| Vol % | 30.0 | 4.0 | 10.0 | 12.0 | 10.0 | 4.0 | 30.0 |
| B[127μ] | | | | | | | |
| Mils | 1.50 | 0.20 | 0.53 | 0.55 | 0.52 | 0.20 | 1.50 |
| Vol % | 40.0 | 4.0 | 10.6 | 11.0 | 10.4 | 4.0 | 30.0 |
| C[152μ] | | | | | | | |
| Mils | 1.80 | 0.30 | 0.60 | 0.60 | 0.60 | 0.30 | 1.80 |
| Vol % | 30.0 | 5.0 | 10.0 | 10.0 | 10.0 | 5.0 | 30.0 |

TABLE 5
Film structures

| | Layers | | | | | | |
|---|---|---|---|---|---|---|---|
| Example | A | B | C | D | E | F | G |
| Ex. 15 | 8% AB3 + 22% | AD3 | PA3 | OB1 | PA3 | AD3 | 60% EN2 + 15% |
| | PE5 + 70% | | | | | | PE5 + 20% |
| | PE4 | | | | | | PE2 + 5% |
| | | | | | | | AB3 |
| A[140μ] | | | | | | | |
| Mils | 1.92 | 0.28 | 0.55 | 0.55 | 0.55 | 0.27 | 1.38 |
| Vol % | 35.0 | 5.0 | 10.0 | 10.0 | 10.0 | 5.0 | 25.0 |
| B[140μ] | | | | | | | |
| Mils | 1.92 | 0.28 | 0.55 | 0.55 | 0.55 | 0.69 | 0.96 |
| Vol % | 35.0 | 5.0 | 10.0 | 10.0 | 10.0 | 12.5 | 17.5 |
| C[140μ] | | | | | | | |
| Mils | 1.92 | 0.28 | 0.55 | 0.55 | 0.55 | 1.10 | 0.55 |
| Vol % | 35.0 | 5.0 | 10.0 | 10.0 | 10.0 | 20.0 | 10.0 |
| EX. 16 | 8% AB3 + 22% | AD3 | 70% PA1 + 30% | OB1 | 70% PA1 + 30% | AD3 | 60% EN2 + 15% |
| | PE5 + 70% | | PA2 | | PA2 | | PE5 + 20% |
| | PEA | | | | | | PE2 + 5% |
| | | | | | | | AB3 |
| A[140μ] | | | | | | | |
| Mils | 1.92 | 0.28 | 0.55 | 0.55 | .55 | 0.27 | 1.38 |
| Vol % | 35.0 | 5.0 | 10.0 | 10.0 | 10.0 | 5.0 | 25.0 |
| B[140μ] | | | | | | | |
| Mils | 1.92 | 0.28 | 0.55 | 0.55 | 0.55 | 0.69 | 0.96 |
| Vol % | 35.0 | 5.0 | 10.0 | 10.0 | 10.0 | 12.5 | 17.5 |
| C[140μ] | | | | | | | |
| Mils | 1.92 | 0.28 | 0.55 | 0.55 | 0.55 | 1.10 | 0.55 |
| Vol % | 35.0 | 5.0 | 10.0 | 10.0 | 10.0 | 20.0 | 10.0 |
| EX. 17 | 8% AB3 + 22% | AD3 | 70% PA1 + 30% | OB1 | 70% PA1 + 30% | AD3 | 60% EN2 + 15% |
| | PE5 + 70% | | PA2 | | PA2 | | PE6 + 20% |
| | PE4 | | | | | | PE2 + 5% |
| | | | | | | | AB3 |
| A[140μ] | | | | | | | |
| Mils | 1.92 | 0.28 | 0.55 | 0.55 | 0.55 | 0.27 | 1.38 |
| Vol % | 35.0 | 5.0 | 10.0 | 10.0 | 10.0 | 5.0 | 25.0 |
| B[140μ] | | | | | | | |
| Mils | 1.92 | 0.28 | 0.55 | 0.55 | 0.55 | 0.69 | 0.96 |
| Vol % | 35.0 | 5.0 | 10.0 | 10.0 | 10.0 | 12.5 | 17.5 |
| C[140μ] | | | | | | | |
| Mils | 1.92 | 0.28 | 0.55 | 0.55 | 0.55 | 1.10 | 0.55 |
| Vol % | 35.0 | 5.0 | 10.0 | 10.0 | 10.0 | 20.0 | 10.0 |
| Ex. 18 | 8% AB1 + 22% | AD1 | 70% PA1 + 30% | OB1 | 70% PA1 + 30% | AD1 | 60% EN2 + 15% |
| | PE5 + 70% | | PA2 | | PA2 | | PE5 + 20% |
| | PE4 | | | | | | PE2 + 5% |
| | | | | | | | AB1 |
| D[127μ] | | | | | | | |
| Mils | 1.75 | 0.20 | 0.53 | 0.55 | 0.52 | 0.20 | 1.25 |
| Vol % | 35.0 | 4.0 | 10.6 | 11.0 | 10.4 | 4.0 | 25.0 |
| E[140μ] | | | | | | | |
| Mils | 1.92 | 0.28 | 0.55 | 0.55 | 0.55 | 0.27 | 1.38 |
| Vol % | 35.0 | 5.0 | 10.0 | 10.0 | 10.0 | 5.0 | 25.0 |
| Comp. 4 | 8% AB3 + 22% | AD1 | 70% PA1 + 30% | OB1 | 70% PA1 + 30% | AD1 | 95% PP4 + 5% |
| | PE5 + 70% | | PA2 | | PA2 | | AB3 |
| | PE4 | | | | | | |
| [140μ] | | | | | | | |
| Mils | 2.0 | 0.54 | 0.55 | 0.55 | 0.55 | 0.55 | 0.76 |
| Vol % | 36.4 | 9.8 | 10.0 | 10.0 | 10.0 | 10.0 | 13.0 |

Note:
In Example 15, AD7 can be substituted for AD3 in layers B and F.

Dimensional stability is a beneficial criteria for an aseptic packaging film. In aseptic processing, the film is typically sterilized in a hydrogen peroxide bath with subsequent drying in an oven, both at a temperature of 60° C. The storage modulus of some of the blown films of the invention that were produced are summarized in Tables 6 and 7 herein. The storage modulus is a function of temperature when tested at a dynamic frequency of 22 rad/sec. The composition of the skin layer of each film is as indicated as all the other layers are substantially the same for all the films. The transverse end seal dimensions of a fin or a lap sealed pouch is used as a measure of pouch dimensional stability. If the transverse end seal difference between the top and bottom seal varies by more than 5 mm, then the film is characterized as dimensionally unstable under aseptic packaging conditions.

TABLE 6

| | Composition | | | | | | | | Dimensional |
|---|---|---|---|---|---|---|---|---|---|
| | of one outer | Storage Modulus, dynes/cm² [×10¹⁰], at | | | | | | | Stability at 60° C. |
| EX. | layer | 20° C. | 30° C. | 40° C. | 50° C. | 60° C. | 70° C. | 80° C. | for ≧2 kg pouch |
| EX. 7A | 80% EN1 + 15% | 1.28 | 0.85 | 0.43 | 0.22 | 0.17 | 0.14 | 0.11 | Marginally Stable |
| [127μ] | PP1 + 05% | | | | | | | | |
| | AB1 | | | | | | | | |
| EX. 7B | EN1[80%] + PP1 | 1.29 | 0.86 | 0.43 | 0.26 | 0.19 | 0.14 | 0.12 | Marginally Stable |
| [152μ] | [15%] + AB1 | | | | | | | | |
| | [05%] | | | | | | | | |
| EX. 8A | EN2[80%] + PP1 | 1.35 | 0.97 | 0.74 | 0.60 | 0.52 | 0.44 | 0.26 | Very Stable |
| [127μ] | [15%] + AB1 | | | | | | | | |
| | [05%] | | | | | | | | |
| EX. 9A | EN2[80%] + PE1 | 1.36 | 0.94 | 0.72 | 0.61 | 0.53 | 0.43 | 0.25 | Very Stable |
| [127μ] | [15%] + AB1 | | | | | | | | |
| | [05%] | | | | | | | | |
| EX. 9B | EN2[80%] + PE1 | 1.34 | 0.90 | 0.55 | 0.42 | 0.34 | 0.27 | 0.19 | Very Stable |
| [152μ] | [15%] + AB1 | | | | | | | | |
| | [05%] | | | | | | | | |
| EX. 9C | EN2[80%] + PE1 | 1.27 | 0.81 | 0.66 | 0.57 | 0.49 | 0.44 | 0.23 | Very Stable |
| [107μ] | [15%] + AB1 | | | | | | | | |
| | [05%] | | | | | | | | |
| EX. 10A | EN2[80%] + PE3 | 1.22 | 0.80 | 0.70 | 0.55 | 0.49 | 0.44 | 0.25 | Very Stable |
| [127μ] | [15%] + AB1 | | | | | | | | |
| | [05%] | | | | | | | | |

TABLE 7

| | Composition | | | | | | | | Dimensional |
|---|---|---|---|---|---|---|---|---|---|
| | of one outer | Storage Modulus, dynes/cm² [E10], at | | | | | | | Stability at 60° C. for |
| EX. | layer | 20° C. | 30° C. | 40° C. | 50° C. | 60° C. | 70° C. | 80° C. | ≧2 kg pouch |
| EX. 11A | 60% EN2 + 15% | | | | | | | | |
| [107μ] | PE5 + 20% | | | | | | | | |
| | PE2 + 05% | | | | | | | | |
| | AB1 | | | | | | | | |
| EX. 11B | 60% EN2 + 15% | 0.80 | 0.60 | 0.46 | 0.38 | 0.34 | 0.31 | 0.15 | Very Stable |
| [127μ] | PE5 + 20% | | | | | | | | |
| | PE2 + 05% | | | | | | | | |
| | AB1 | | | | | | | | |
| EX. 11C | 60% EN2 + 15% | | | | | | | | Very Stable |
| [152μ] | PE5 + 20% | | | | | | | | |
| | PE2 + 05% | | | | | | | | |
| | AB1 | | | | | | | | |
| EX. 11D | 60% EN2 + 15% | 0.76 | 0.59 | 0.57 | 0.48 | 0.38 | 0.32 | 0.17 | Very Stable |
| [127μ] | PE5 + 20% | | | | | | | | |
| | PE2 + 05% | | | | | | | | |
| | AB1 | | | | | | | | |
| EX. 12A | 53% EN2 + 19% | | | | | | | | |
| [107μ] | PE1 + 24% | | | | | | | | |
| | PE2 + 04% | | | | | | | | |
| | AB2 | | | | | | | | |
| EX. 12B | 53% EN2 + 19% | 0.66 | 0.46 | 0.39 | 0.35 | 0.29 | 0.30 | 0.14 | Stable |
| [127μ] | PE1 + 24% | | | | | | | | |
| | PE2 + 04% | | | | | | | | |
| | AB2 | | | | | | | | |
| EX. 13A | 53% EN2 + 19% | 1.55 | 1.20 | 0.80 | 0.60 | 0.44 | 0.34 | 0.15 | Very Stable |
| [107μ] | PE3 + 24% | | | | | | | | |
| | PE2 + 04% | | | | | | | | |
| | AB2 | | | | | | | | |
| EX. 13B | 53% EN2 + 19% | 1.15 | 0.85 | 0.58 | 0.50 | 0.38 | 0.33 | 0.15 | Very Stable |
| [127μ] | PE3 + 24% | | | | | | | | |
| | PE2 + 04% | | | | | | | | |
| | AB2 | | | | | | | | |
| EX. 13C | 53% EN2 + 19% | 0.95 | 0.63 | 0.54 | 0.48 | 0.36 | 0.32 | 0.15 | Very Stable |
| [152μ] | PE3 + 24% | | | | | | | | |
| | PE2 + 04% | | | | | | | | |
| | AB2 | | | | | | | | |
| EX. 14A | 53% EN2 + 19% | | | | | | | | |
| [107μ] | PP3 + 24% | | | | | | | | |
| | PE2 + 04% | | | | | | | | |
| | AB2 | | | | | | | | |
| EX. 14B | 53% EN2 + 19% | 1.1 | 0.84 | 0.56 | 0.44 | 0.30 | 0.33 | 0.15 | Stable |
| [127μ] | PP3 + 24% | | | | | | | | |
| | PE2 + 04% | | | | | | | | |
| | AB2 | | | | | | | | |
| Comp. 5 | BIAX PA6 | 0.75 | 0.68 | 0.57 | 0.52 | 0.47 | 0.44 | 0.38 | Stable |
| | Laminate | | | | | | | | |
| Comp. 6 | BIAX PA6 | 0.90 | 0.78 | 0.60 | 0.45 | 0.36 | 0.28 | 0.23 | Stable |
| | Laminate | | | | | | | | |

Notes to the Tables:
1. “Comp.” refers to a comparative example.
2. “Ex.” refers to an example of the invention.
3. The thickness of each layer, in mils (one mil = .001 inches) is indicated.
4. “μ” refers to micrometers.
5. Some film examples (e.g. Example 7) were extruded in more than one thickness. The Tables indicate the thickness for each run.

TABLE 8

| EX. | A | B | C | D | E | F | G |
|---|---|---|---|---|---|---|---|
| 19 | 70% PE4 + 22% | AD3 | PA3 | OB1 | PA3 | AD3 | 60% EN2 + 15% |
| | PE5 + 8% | | | | | | PE6 + 20% |
| | AB3 | | | | | | PE2 + 5% |
| | | | | | | | AB3 |
| Mils | 1.92 | 0.28 | 0.55 | 0.55 | 0.55 | 1.10 | 0.55 |
| 20 | 70% PE4 + 22% | 60% AD4 + 40% | PA3 | OB1 | PA3 | AD3 | 60% EN2 + 15% |
| | PE5 + 8% | AD5 | | | | | PE6 + 20% |
| | AB3 | | | | | | PE2 + 5% |
| | | | | | | | AB3 |
| Mils | 1.92 | 0.28 | 0.55 | 0.55 | 0.55 | 1.10 | 0.55 |
| 21 | 70% PE4 + 22% | EA1 | PA3 | OB1 | PA3 | AD3 | 60% EN2 + 15% |
| | PE5 + 8% | | | | | | PE6 + 20% |
| | AB3 | | | | | | PE2 + 5% |
| | | | | | | | AB3 |
| Mils | 1.92 | 0.28 | 0.55 | 0.55 | 0.55 | 1.10 | 0.55 |
| 22 | 70% PE4 + 22% | EA2 | PA3 | OB1 | PA3 | AD3 | 60% EN2 + 15% |
| | PE5 + 8% | | | | | | PE6 + 20% |
| | AB3 | | | | | | PE2 + 5% |
| | | | | | | | AB3 |
| Mils | 1.92 | 0.28 | 0.55 | 0.55 | 0.55 | 1.10 | 0.55 |
| 23 | 70% PE4 + 22% | IO1 | PA3 | OB1 | PA3 | AD3 | 60% EN2 + 15% |
| | PE5 + 8% | | | | | | PE6 + 20% |
| | AB3 | | | | | | PE2 + 5% |
| | | | | | | | AB3 |
| Mils | 1.92 | 0.28 | 0.55 | 0.55 | 0.55 | 1.10 | 0.55 |
| 24 | 70% PE4 + 22% | IO2 | PA3 | OB1 | PA3 | AD3 | 60% EN2 + 15% |
| | PE5 + 8% | | | | | | PE6 + 20% |
| | AB3 | | | | | | PE2 + 5% |
| | | | | | | | AB3 |
| Mils | 1.92 | 0.28 | 0.55 | 0.55 | 0.55 | 1.10 | 0.55 |

Notes to Table 8:
1. For Example 20, an alternative to the 60/40 blend of layer B is to use 100% AD6.
2. Layer A can in some embodiments function as a sealant layer, typically the layer closest to the article to be packaged; layer G as a skin or outer layer, typically the layer farthest from the article to be packaged.

In one alternative embodiment, a film structure in accordance with the invention can be as follows:

| | | | | | | | | |
|---|---|---|---|---|---|---|---|---|
| Ex. 25 | 70% PE4 + 22% | AD6 | EA1 | PA3 | OB1 | PA3 | AD3 | 60% EN2 + 15% |
| | PE5 + 8% | | | | | | | PE6 + 20% |
| | AB3 | | | | | | | PE2 + 5% |
| | | | | | | | | AB3 |

where layer B (comprising AD6) comprises less than 3% by volume of the film structure.

In another alternative embodiment, a film structure in accordance with the invention can be as follows:

| | | | | | | | | |
|---|---|---|---|---|---|---|---|---|
| Ex. 26 | 70% PE4 + 22% | AD6 | EA1 | PA3 | OB1 | PA3 | AD3 | 30% EN2 + 30% |
| | PE5 + 8% | | | | | | | PE6 + 35% |
| | AB3 | | | | | | | PE2 + 5% |
| | | | | | | | | AB3 |

Examples 19 to 25 were made. Example 26 is a prophetic example. The films of Examples 19 to 25 are dimensionally stable under aseptic conditions for pouches containing between 2 and 5 kilograms of product. That is, these films when formed into a pouch and filled with a product, exhibit minimal dimensional variation from pouch to pouch. For example, ten pouches were made in accordance with Example 19. These were each nominally 500 mm long and 315 mm wide. It was found that the variation in the length of the pouches was within ±2 mm.

What is claimed is:

1. A coextruded multilayer film comprising:
a) a core layer comprising ethylene vinyl alcohol copolymer;
b) two intermediate layers each comprising polyamide;
c) a first outer layer comprising amorphous cyclic olefin copolymer;
d) a second outer layer comprising an amorphous cyclic olefin copolymer or an olefinic copolymer; and
e) two tie layers each adhering an intermediate layer to a respective outer layer.

2. The coextruded multilayer film of claim 1 wherein the polyamide comprises nylon 6.

3. The coextruded multilayer film of claim 1 wherein at least one of the intermediate layers comprises a blend of an amorphous polyamide having a glass transition temperature of at least 80° C., and a semicrystalline polyamide.

4. The coextruded multilayer film of claim 1 wherein the amorphous cyclic olefin copolymer is ethylene norbornene copolymer.

5. The coextruded multilayer film of claim 1 wherein the first outer layer comprises a blend of amorphous cyclic olefin copolymer and semicrystalline olefinic polymer.

6. The coextruded multilayer film of claim 5 wherein the semicrystalline olefinic polymer is selected from the group consisting of ethylene polymer, ethylene copolymer, and polypropylene.

7. The coextruded multilayer film of claim 1 wherein the olefinic polymer, of the second outer layer, is selected from the group consisting of
a) a blend of low density polyethylene and linear low density polyethylene;
b) a blend of low density polyethylene and an ethylene/alpha-olefin interpenetrating network resin;
c) propylene/ethylene copolymer;
d) high density polyethylene;
e) propylene homopolymer; and
f) ethylene/norbornene copolymer.

8. The coextruded multilayer film of claim 1 wherein the tie layers each comprise an anhydride grafted polymer or ethylene/acrylic acid copolymer.

9. The coextruded multilayer film of claim 1 wherein the film exhibits an elongation at yield (ASTM D 882) of less than 15% in each of the longitudinal and transverse directions.

10. The coextruded multilayer film of claim 1 wherein the film exhibits a free shrink (ASTM D 2732) at 200° F. of less than 8% in each of the longitudinal and transverse directions.

11. An aseptic package comprises:
a) a sterilized food product, and
b) a sterilized pouch in which the sterilized food product is disposed, the sterilized pouch comprising a coextruded multilayer film comprising
i) a core layer comprising ethylene vinyl alcohol copolymer;
ii) two intermediate layers each comprising polyamide;
iii) a first outer layer comprising a material selected from the group consisting of amorphous cyclic olefin copolymer, aliphatic homopolyamide, aromatic polyamide, aromatic copolyamide, polycarbonate, polyethylene terephthalate, polyethylene naphthalate, polyethylene terephthalate/naphthalate, and polybutylene naphthalate;
iv) a second outer layer comprising a material selected from the group consisting of amorphous cyclic olefin copolymer, aliphatic homopolyamide, aromatic polyamide, aromatic copolyamide, and olefinic copolymer; and
v) two tie layers each adhering an intermediate layer to a respective outer layer.

12. The coextruded multilayer film of claim 11 wherein the polyamide of each of the intermediate layers comprises nylon 6.

13. The coextruded multilayer film of claim 11 wherein at least one of the intermediate layers comprises a blend of an amorphous polyamide having a glass transition temperature of at least 80° C., and a semicrystalline polyamide.

14. The coextruded multilayer film of claim 11 wherein the amorphous cyclic olefin copolymer is ethylene norbornene copolymer.

15. The coextruded multilayer film of claim 11 wherein the first outer layer comprises a blend of amorphous cyclic olefin copolymer and semicrystalline olefinic polymer.

16. The coextruded multilayer film of claim 15 wherein the semicrystalline olefinic polymer, of the first outer layer, is selected from the group consisting of ethylene polymer, ethylene copolymer, and polypropylene.

17. The coextruded multilayer film of claim 11 wherein the olefinic polymer, of the second outer layer, is selected from the group consisting of
a) a blend of low density polyethylene and linear low density polyethylene;
b) a blend of low density polyethylene and an ethylene/alpha-olefin interpenetrating network resin;
c) propylene/ethylene copolymer;
d) high density polyethylene;
e) propylene homopolymer; and
f) ethylene/norbornene copolymer.

18. The coextruded multilayer film of claim 11 wherein the film exhibits
i) an elongation at yield (ASTM D 882) of less than 15% in each of the longitudinal and transverse directions, and
ii) a free shrink (ASTM D 2732) at 200° F. of less than 8% in each of the longitudinal and transverse directions.

19. A method of making an aseptic package comprising:
a) sterilizing a food product;
b) sterilizing a coextruded film, the film comprising:
i) a core layer comprising ethylene vinyl alcohol copolymer;
ii) two intermediate layers each comprising polyamide;
iii) a first outer layer comprising a material selected from the group consisting of amorphous cyclic olefin copolymer, aliphatic homopolyamide, aromatic polyamide, aromatic copolyamide, polycarbonate, polyethylene terephthalate, polyethylene naphthalate, polyethylene terephthalate/naphthalate, and polybutylene naphthalate;
iv) a second outer layer comprising a material selected from the group consisting of amorphous cyclic olefin copolymer, aliphatic homopolyamide, aromatic polyamide, aromatic copolyamide, and olefinic copolymer; and
v) two tie layers each adhering an intermediate layer to a respective outer layer;
wherein the film exhibits
an elongation at yield (ASTM D 882) of less than 15% in each of the longitudinal and transverse directions, and
a free shrink (ASTM D 2732) at 200° F. of less than 8% in each of the longitudinal and transverse directions;
c) forming the sterilized film into a pouch;
d) filling the pouch with the sterilized food product; and
e) sealing the pouch.

20. The method of claim 19 wherein the amorphous cyclic olefin copolymer is ethylene norbornene copolymer.
